(19) United States
(12) Patent Application Publication
(10) Pub. No.: US 2009/0285138 A1
(43) Pub. Date: Nov. 19, 2009

(54) Maintaining wireless communication between Consumer Electronic Control devices

(75) Inventors: John Thomas, Fremont, CA (US); Michael Cavallo, San Jose, CA (US)

Correspondence Address: Tzero Technologies, Inc., PO Box 641867, San Jose, CA, 95164-1867, US

(73) Assignee: Tzero Technologies, Inc.

(21) Appl. No.: 12/152,169

(22) Filed: May 13, 2008

(51) Int. Cl. H04B 7/00

(52) U.S. Cl. 370/310

(57) ABSTRACT

Methods and systems of wireless nodes maintaining communication between CEC capable devices are disclosed. One method includes assigning physical addresses to the two wireless nodes based on a physical location of the two wireless nodes relative to a base CEC capable device. Each of the two wireless nodes receives logical addresses from CEC capable devices that are wire attached to each of the two wireless nodes. Each of the two wireless nodes creating a proxy table that includes logical addresses of the CEC capable devices wire attached to the other of the two wireless nodes. Each of the two wireless nodes responds with a proxy acknowledgement when the wireless node receives a packet intended for at least one of the CEC capable devices that is wire connected to the other wireless node, wherein the wireless node has an establish wireless link with the other wireless node.

### FIELD OF THE DESCRIBED EMBODIMENTS

The described embodiments relate generally to communication systems. More particularly, the described embodiments relate to a method and apparatus for maintaining communication between consumer electronic control (CEC) devices through a wireless link.

### BACKGROUND

One goal of the digital revolution is to create increasingly intelligent consumer electronics (CE) devices and systems that can automatically configure themselves, correct errors, and free the user from having to manage them. The High-Definition Multimedia Interface (HDMI) provides the framework for delivering on this goal, not only by drastically simplifying cabling, but by establishing a structural basis for system-wide intelligence.

HDMI is a compact audio/video connector interface for transmitting uncompressed digital streams. It represents a digital alternative to consumer analog standards such as RF (coaxial cable), composite video, S-Video, SCART, component video and VGA. HDMI can be used to connects digital audio/video sources such as a set-top box, a Blu-ray Disc player, a personal computer, a video game console, or an AV receiver to a compatible digital audio device and/or video monitor such as a digital television (DTV). HDMI began to appear in 2006 on consumer HDTV camcorders and high-end digital still cameras.

The optional Consumer Electronic Control (CEC) feature of the HDMI specification offers a powerful opportunity for system-level automation and unmatched ease of use when all devices in an entertainment system are equipped to support it. For example, when viewing content on an HDTV, a CEC-enabled HDTV remote can be used to play or rewind movies, manage power-on, input selection, and power-off functions for the TV, set-top box, and audio/video receiver, switch inputs and outputs, or change video and audio modes.

FIG. 1 shows an example of an indoor broad band wireless communication network 100 such as a UWB network. The exemplary network 100 includes a high definition television (HDTV) monitor 110 networked with other devices, such as, a digital video recorder (DVR) 120, a digital video disk (DVD) player 140 and a computing device 130. Wireless network are not encumbered by wire connections between devices.

It is desirable to have the control provided by CEC-enabled devices, but also have the flexibility that a wireless network provides. However, wireless networks have not been developed that allow for CEC control over wireless links.

### SUMMARY

An embodiment includes a method of two wireless nodes maintaining communication between CEC capable devices. The method includes assigning physical addresses to the two wireless nodes based on a physical location of the two wireless nodes relative to a base CEC capable device. Each of the two wireless nodes receives logical addresses from CEC capable devices that are wire attached to each of the two wireless nodes. Each of the two wireless nodes create a proxy table that includes logical addresses of the CEC capable devices wire attached to the other of the two wireless nodes. Each of the two wireless nodes responds with a proxy acknowledgement when the wireless node receives a packet intended for one of the CEC capable devices that is wire connected to the other wireless node, wherein the wireless node has an establish wireless link with the other wireless node.

Another embodiment includes a wireless network for maintaining communication between CEC networks. The network includes a first wireless node that receives logical addresses from CEC capable devices wire attached to the first wireless node. A second wireless node receives logical addresses from CEC capable devices wire attached to the second wireless node. The first wireless node creates a proxy table that includes logical addresses of the CEC capable devices wire attached to the second wireless node. The second wireless node creates a proxy table that includes logical addresses of the CEC capable devices wire attached to the first wireless node. The first wireless node responds with a proxy acknowledgement when the first wireless node receives a packet intended for at least one of the CEC capable devices that is wire connected to the second wireless node, wherein the first wireless node has an establish wireless link with the second wireless node. The second wireless node responds with a proxy acknowledgement when the second wireless node receives a packet intended for at least one of the CEC capable devices that is wire connected to the first wireless node, wherein the second wireless node has an establish wireless link with the first wireless node.

Another embodiment includes a method of wireless nodes maintaining communication between devices. The method includes assigning physical addresses to the two wireless nodes based on a physical location of the two wireless nodes relative to a base device. Each of the two wireless nodes receives logical addresses from devices that are wire attached to each of the two wireless nodes. Each of the two wireless nodes create a proxy table that includes logical addresses of the devices wire attached to the other of the two wireless nodes. Each of the two wireless nodes responds with a proxy acknowledgement when the wireless node receives a packet intended for one of the devices that is wire connected to the other wireless node, wherein the wireless node has an establish wireless link with the other wireless node.

### BRIEF DESCRIPTION OF THE DRAWINGS

FIG. 1 shows an example of an indoor broad band wireless communication network

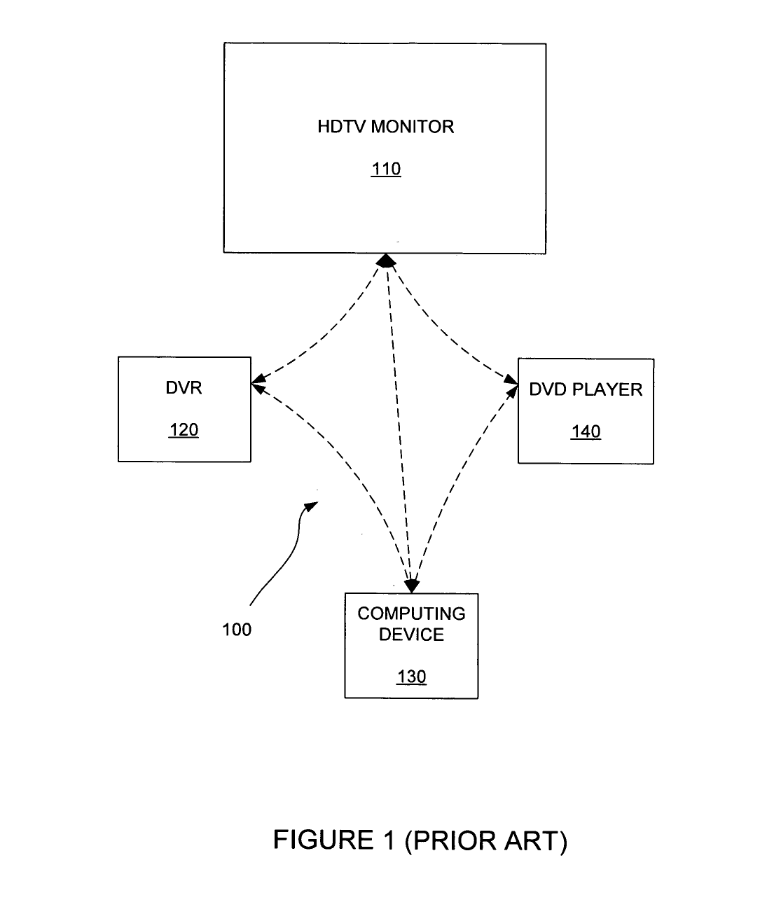

FIG. 2 shows an example of CEC networks that includes a wireless link between CEC capable devices.

FIG. 3 is a flow chart that shows steps of an example of a method wireless nodes maintaining communication between CEC capable devices.

FIG. 4 is a flow chart that shows steps of an example of a method of adding the logical address of the initiator CEC capable device to a proxy table.

FIG. 5 is a flow chart that shows steps of an example of a method removing a logical address from a proxy table.

FIG. 6 is a flow chart that shows steps of an example of a method of cycling through proxy tables to ensure they are current.

### DETAILED DESCRIPTION

The embodiments described include methods of maintaining communication between CEC capable devices, wherein at least one wireless link is located between the CEC capable devices. The wireless link can be supported, for example, by a wireless (UWB) network. The network includes each wireless node maintaining a proxy table that includes addresses of CEC capable devices connected to other wireless nodes. When the wireless node receives a message having a destination address of a CEC capable device connected to one of the other wireless nodes, the wireless node can access its proxy table and respond with an acknowledgement.

CEC signals reside on a single pin of an HDMI connector. The CEC protocol provides high-level control functions between various audiovisual products. Each CEC packet is 10 bits long. The first packet of a CEC message is a header that includes a 4 bit source, a 4 bit destination address, a 1 bit end of message (EOM) bit, and a 1 bit acknowledgement (ACK) bit. The CEC signal (that is, the line the CEC signal is on) is physically connected to each node (CEC device) on a CEC network. Therefore, all CEC messages are received by every node. That is, there is no method for sending a private message from one CEC device to another CEC device without the other CEC devices of the CEC network receiving the message.

CEC messages are conveyed in a single frame that includes a number of data bits. The initiator of a CEC message set the 10^{th} bit of the CEC message such that when the follower (recipient) reads its own address in the destination address field it acknowledges by driving the 10^{th} bit (ACK bit) low. If the ACK bit is not held low, the sender of the CEC message interprets this as a failure, and assumes that either the source node does not exist, the CEC command is not supported by the recipient, or that there is an error in the data being sent.

When transmitting CEC messages over a wireless network, the nodes are not physically connected to one another. Therefore, it is not possible for a node on one side of the wireless network to acknowledge (ACK) CEC messages generated by a node on the other side of the wireless network. The proxy table maintained by each wireless node provides each wireless node with the ability to provide the acknowledgments to CEC messages required for proper operation of CEC networks that are wirelessly connected.

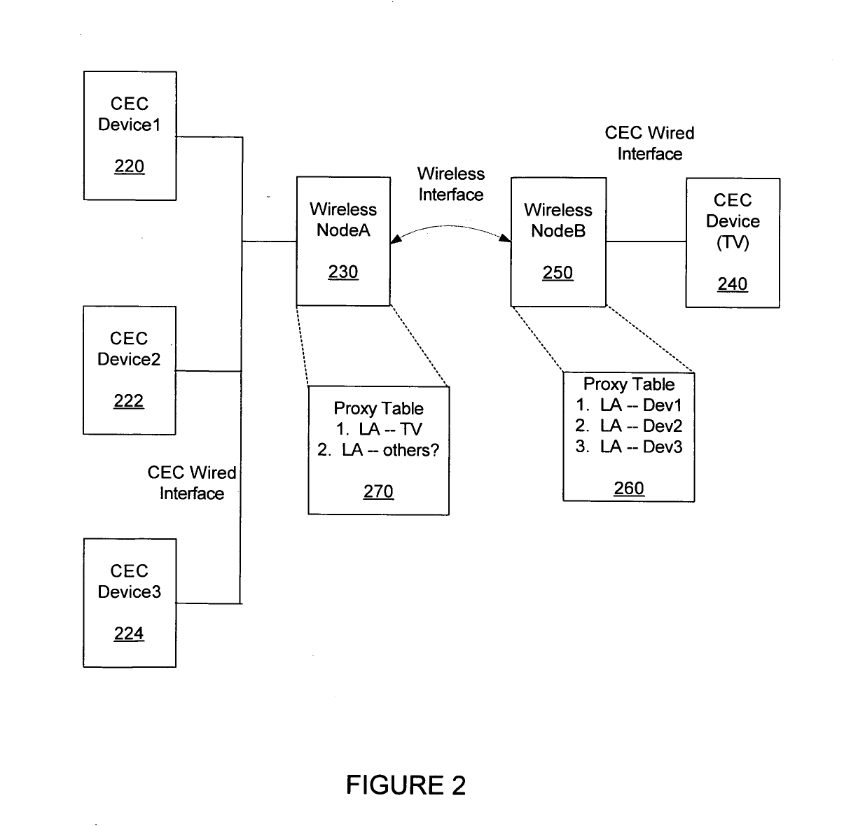

FIG. 2 shows an example of CEC networks that includes a wireless link between CEC capable devices. A first CEC network includes CEC capable devices 220, 222, 224 which are wire connected (through a CEC compatible interface) to a wireless node 230. These CEC capable devices can send messages and reserve addresses between them selves consistent with a standard CEC network.

A second CEC network includes a CEC device 240 (shown as a TV (television)). The CEC device 240 is wire connected through a CEC compatible interface to second wireless node 250. The second CEC network is shown with one CEC capable device 240. However, it is to be understood that the second CEC network can include multiple CEC capable devices as well. Additionally, the CEC device 240 is shown as a TV (or display), but can be one of any number of CEC capable devices.

The CEC devices are shown as separate from the wireless nodes. However, the CEC devices and the wireless nodes can be formed as a single unit. Multiple of such single units can then wirelessly communicate between themselves.

In normal operation, the wireless nodes 230, 250 use the logical addresses (LAs) of their corresponding proxy tables 260, 270 to allow them to acknowledge messages sent from CEC capable devices that are wire connected to them, and that are destined for CEC capable devices that are wire connected to another wireless node. For example, if CEC device 222 sends a message having a destination address of the CEC device 240, the wireless node 230 will respond with an acknowledgement because the proxy table 270 of the wireless node 230 has the logical address of the CEC device (TV) 240. If, for example, the CEC device 240 sends a message having a destination address of the CEC device 224, the wireless node 250 will respond with an acknowledgement because the proxy table 260 of the wireless node 250 has the logical address of the CEC device 220. The result is that the CEC capable devices can operate as though there is a wired connection between them.

While the described embodiments include a wireless link (such as, a UWB or other wireless protocol) between CEC networks, it is to be understood that the embodiments can alternatively be implemented with a wired link between the CEC networks. Additionally, CEC is a part of an HDMI cable, however, CEC may be developed with other types of cables as well. It should also be understood that other networks can include “CEC like” features and operations. Clearly, the described embodiments include these “CEC like” networks as well.

The described embodiments include methods for building the proxy tables, adding entries to the proxy tables, deleting entries from the proxy tables, and cycling the proxy tables to ensure that they are current. The proxy tables enable the wireless nodes to properly acknowledge messages sent from CEC capable devices.

Building Proxy Tables

Before the proxy tables can be built, the devices of one or more CEC networks complete an address discovery process. For an embodiment, a base CEC capable device (for an embodiment, the base CEC capable device is a TV) sets up an EDID for each of its HDMI ports with an appropriate physical address (PA). For example, a TV may have two ports that are assigned PAs of PA=1.0.0.0 for HDMI Port 1, and PA=2.0.0.0 for HDMI Port 2. A wireless node (such as, wireless node 250) that is wire connected (or a part of) the TV reads the EDID it is connected to, for example, to Port 1, and assumes the PA of 1.0.0.0. The wireless node the wirelessly transmits the physical address to a wirelessly link other wireless node (such as, wireless node 230), and the other wireless node assumes the PA=1.0.0.0 is a sink, and then sets up EDIDs on its ports. For example, the other wireless node sets up a PA=1.1.0.0 on a Port1, and sets up a PA=1.2.0.0 on a Port2.

CEC capable devices wire connected to the ports of the other wireless node upon detecting a low to high on HPD reads the EDID from the other wireless node, set their PA, and begin logical address (LA) discovery. For example, the CEC Device1 220 (which can be, for example, a DVD player) detects the low to high on HPD from wireless node 230 and reads its PA from the EDID on Port1 of the other wireless node 230. CEC Device1 220 will send an empty message to LA=4 to see if that LA is free. If CEC Device1 220 does not sense an ACK, it will assume LA=4 is free and assign it's LA to 4. Similarly, CEC Device2 222 upon detecting the low to high on HPD from wireless node 230 will read it's PA from the EDID on Port2. CEC Device2 222, being a DVD player, will try LA=4 but will receive an ACK from Device1 220. CEC Device2 222 will then try the next possible LA=8, and upon not receiving an ACK will assign itself to LA=8. The CEC Device3 224 similarly sets its PA and LA.

Once the CEC devices have assigned their PA and discovered their LA, they broadcast their LA and PA in a message. The other wireless node 230 relays the message to the wireless node 250. The wireless node 250 records the LAs of each CEC capable device (220, 222, 224) wire connected to the other wireless node 230. Each of the CEC capable networks have wireless nodes that relay messages of the LA and PA of the CEC capable devices wire connected to the wireless nodes. Therefore, each wireless node has a proxy table entry for the CEC capable devices wire connected to the other wireless nodes that the wireless node is able to maintain a wireless connection. It should be understood that the described embodiments typically relay the messages during LA discovery.

Once the proxy tables have been built, each wireless node can properly acknowledge messages sent by one of the CEC capable devices that are connected to the wireless node having destination address of CEC capable devices that are connected to other wireless nodes. For example, the TV 240 can send a <play> command to LA=8 (DVD2). The wireless node 250 receives that command and responds with an acknowledgement because the LA=8 is within its proxy table 260. The wireless node 250 also relays the message to the other wireless node 230 over the wireless link. The other wireless node then sends the <play> message out over its CEC network. The message is received by the CEC capable device (DVD2) 222 because of the PA of the message. The DVD2 222 begins playing and broadcasts a <set stream path> message. The other wireless node 230 receives the <set stream path> message and identifies the PA within the message, and therefore, switches to the Port2. The other wireless node 230 wirelessly transmits the <set stream path> message to the wireless node 250. The wireless node 250 sends the <set stream path> message out over its wired CEC network. The TV receives the message over the CEC network, identifies the PA, and switches its input to receive over the Port1, and plays the original broadcast of the DVD2 222.

Adding an Address to a Proxy Table

Once the proxy tables have been built, entries to the proxy table can be added as new devices are added to the CEC networks. The new CEC device (also referred to as an initiator) first assigns itself a PA and discovers an LA. The initiator device then sends a message out over its CEC network, wherein the message includes a destination LA. A wireless node connected to the CEC network responds with an acknowledgement if the destination LA is within its proxy table. The wireless node also wirelessly transmits the message, wherein the message includes the LA of the initiator device, and the destination LA. An other wireless node that is connected to the CEC network of the device having the destination LA adds the initiator LA to its proxy table for future reference. The other wireless device forwards the message to the device having the destination LA. It is to be understood that additions to the proxy table does occur on every relayed message.

Deleting an Address from a Proxy Table

Once the proxy tables have been built, entries to the proxy table can be subtracted as devices are dropped from the CEC networks. One method of subtracting an entry begins with a CEC device transmitting a message that includes an LA of a destination device connected to another CEC network. A wireless node of the CEC network receives the message and responds with an acknowledgement (that is, the proxy table of the wireless node has not yet been updated). The wireless node wirelessly transmits the message including the destination device to another wireless node the at least previously was wire connected to the destination device. The other wireless node broadcasts the message over its CEC network. If the destination device is no longer connected to the CEC network, the other wireless node will not receive an acknowledgement. If no acknowledgement is received, the other wireless node wirelessly transmits an error message back to the wireless node. The wireless node then deletes the destination LA from its proxy table.

Cycling Proxy Tables to Ensure They are Current

An embodiment includes the wireless nodes periodically or intermittently cycling through the LSs of their proxy tables to determine whether they are current. One embodiment includes a wireless node cycling through all of the LAs of its proxy table, and wirelessly transmitting messages having the LAs to the other wireless node that correspond to the LAs (that is, the wireless node that the proxy table indicates is wire connected to each device corresponding to each of the LAs). The other wireless node then broadcasts messages with the LAs over its CEC network and monitors which generate an acknowledgement. The other wireless node then responds back to the wireless node with a control message that includes information indicating which of the LAs generated acknowledgements. The wireless node then updates its proxy table based on the information.

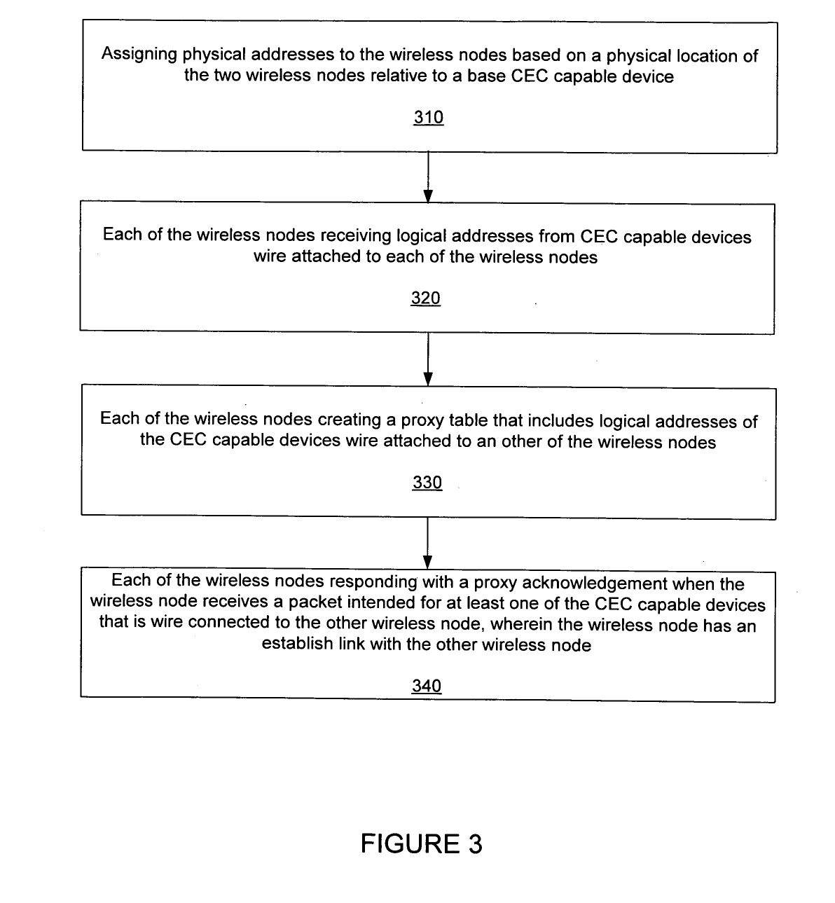

FIG. 3 is a flow chart that shows steps of an example of a method wireless nodes maintaining communication between CEC capable devices. A first step 310 includes assigning physical addresses to the wireless nodes based on a physical location of the two wireless nodes relative to a base CEC capable device. A second step 320 includes each of the wireless nodes receiving logical addresses from CEC capable devices wire attached to each of the wireless nodes. A third step 330 includes each of the wireless nodes creating a proxy table that includes logical addresses of the CEC capable devices wire attached to an other of the wireless nodes. A fourth step 340 includes each of the wireless nodes responding with a proxy acknowledgement when the wireless node receives a packet intended for at least one of the CEC capable devices that is wire connected to the other wireless node, wherein the wireless node has an establish link with the other wireless node. The described embodiment primarily includes a wireless link with the other wireless node, but an embodiment includes the link being a wired link.

An embodiment includes the base CEC capable device being a display monitor. It is to be understood, however, that the base CEC capable device is not required to be a display monitor.

As described, the proxy table of each wireless node, allows each wireless node to determine the logical address of CEC capable devices directly connected to other wireless nodes, and appropriately respond with proxy acknowledgements to CEC capable devices wire connected to the wireless node.

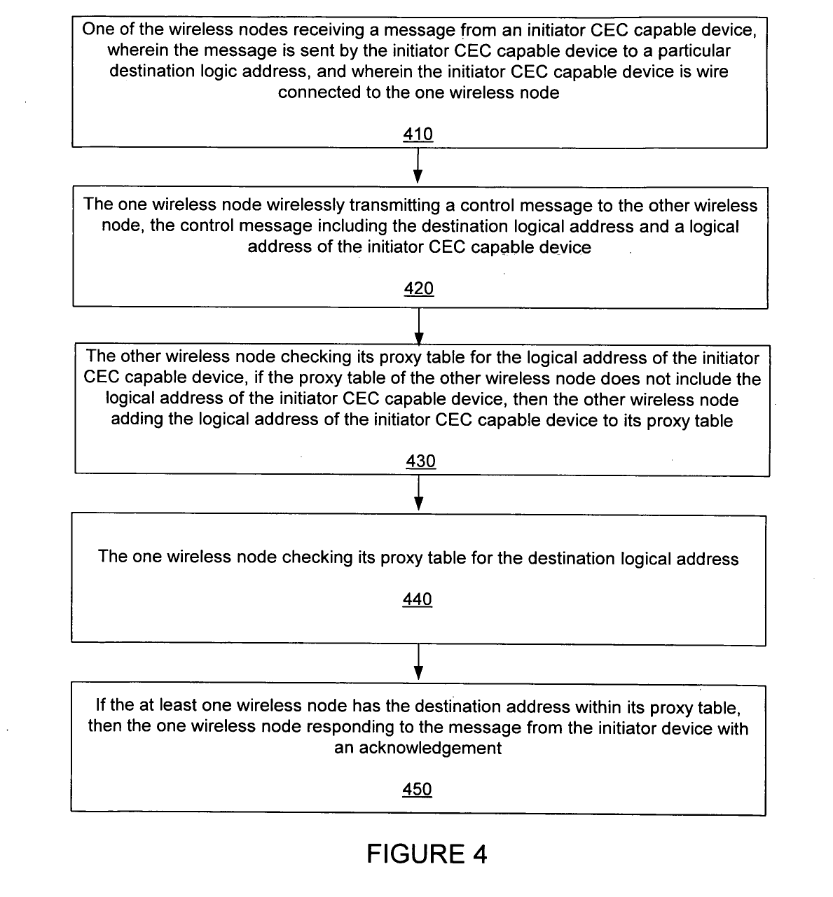

FIG. 4 is a flow chart that shows steps of an example of a method of adding the logical address of the initiator CEC capable device to a proxy table. A first step 410 includes one of the wireless nodes receiving a message from an initiator CEC capable device, wherein the message is sent by the initiator CEC capable device to a particular destination logic address, and wherein the initiator CEC capable device is wire connected to the one wireless node. A second step 420 includes the one wireless node wirelessly transmitting a control message to the other wireless node, the control message including the destination logical address and a logical address of the initiator CEC capable device. A third step 430 includes the other wireless node checking its proxy table for the logical address of the initiator CEC capable device, if the proxy table of the other wireless node does not include the logical address of the initiator CEC capable device, then the other wireless node adding the logical address of the initiator CEC capable device to its proxy table. A fourth step 440 includes the one wireless node checking its proxy table for the destination logical address. A fifth step 450 includes if the at least one wireless node has the destination address within its proxy table, then the one wireless node responding to the message from the initiator device with an acknowledgement.

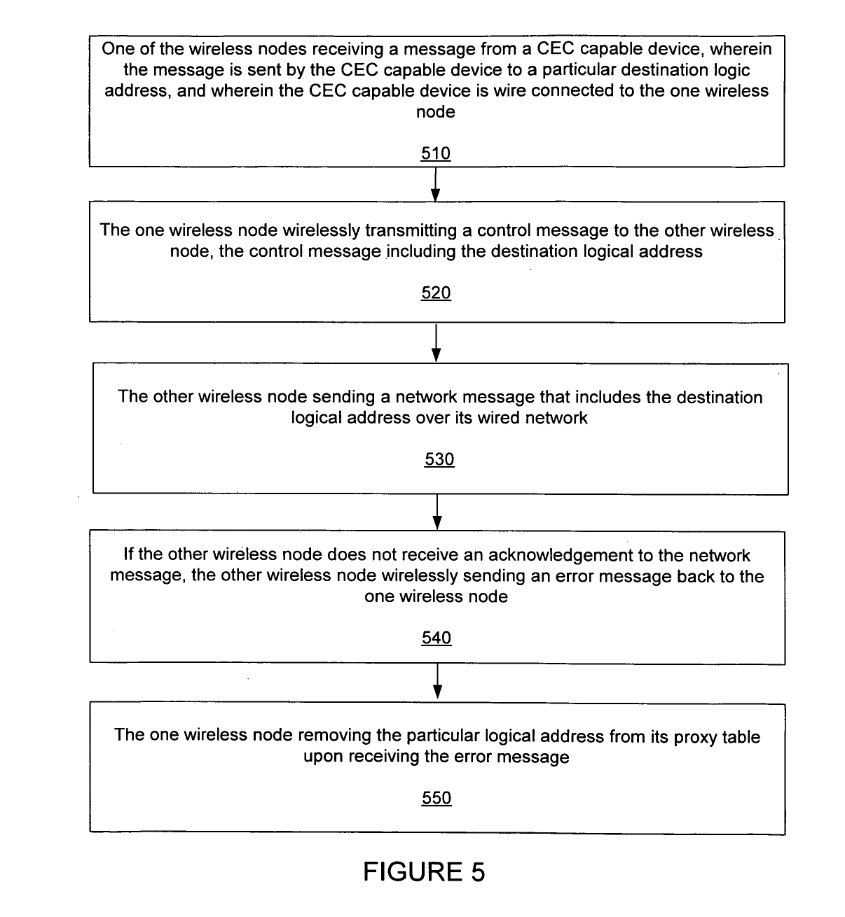

FIG. 5 is a flow chart that shows steps of an example of a method removing a logical address from a proxy table. A first step 510 includes one of the wireless nodes receiving a message from a CEC capable device, wherein the message is sent by the CEC capable device to a particular destination logic address, and wherein the CEC capable device is wire connected to the one wireless node. A second step 520 includes the one wireless node wirelessly transmitting a control message to the other wireless node, the control message including the destination logical address. A third step 530 includes the other wireless node sending a network message that includes the destination logical address over its wired network. A fourth step 540 includes if the other wireless node does not receive an acknowledgement to the network message, the other wireless node wirelessly sending an error message back to the one wireless node. A fifth step 550 includes the one wireless node removing the particular logical address from its proxy table upon receiving the error message.

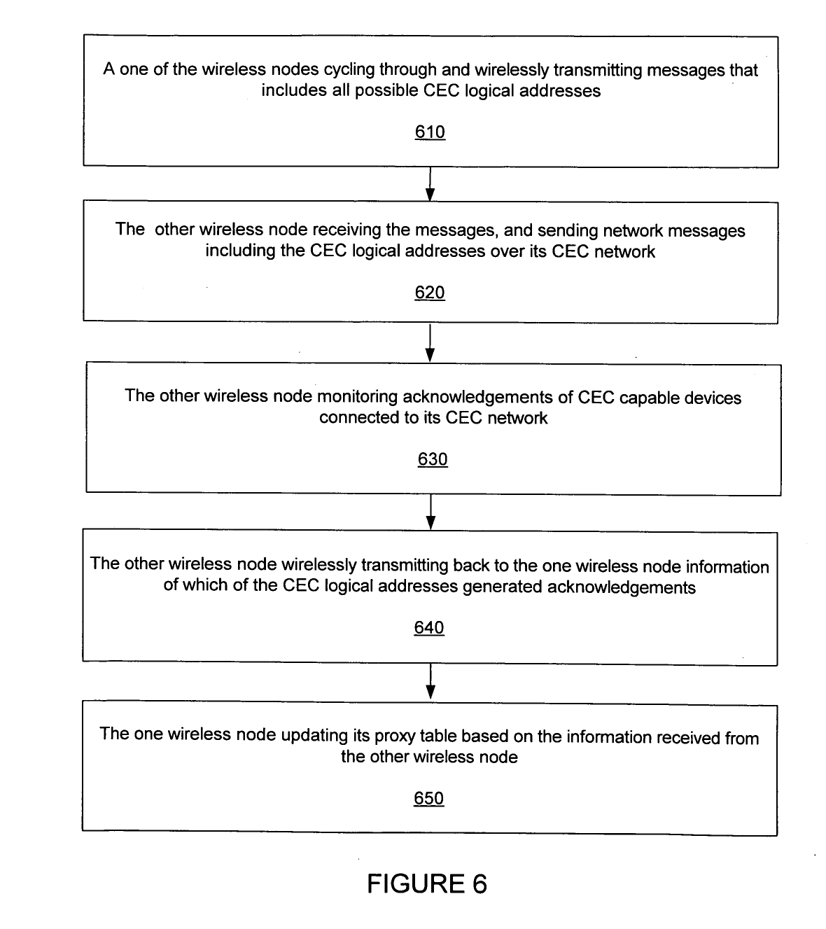

FIG. 6 is a flow chart that shows steps of an example of a method of cycling through proxy tables to ensure they are current. A first step 610 includes a one of the wireless nodes cycling through and wirelessly transmitting messages that includes all possible CEC logical addresses. A second step 620 includes the other wireless node receiving the messages, and sending network messages including the CEC logical addresses over its CEC network. A third step 630 includes the other wireless node monitoring acknowledgements of CEC capable devices connected to its CEC network. A fourth step 640 includes the other wireless node wirelessly transmitting back to the one wireless node information of which of the CEC logical addresses generated acknowledgements. A fifth step 650 includes the one wireless node updating its proxy table based on the information received from the other wireless node.

Although specific embodiments have been described and illustrated, the embodiments are not to be limited to the specific forms or arrangements of parts so described and illustrated.

What is claimed:

1. A method of wireless nodes maintaining communication between CEC capable devices, comprising:
assigning physical addresses to the wireless nodes based on a physical location of the two wireless nodes relative to a base CEC capable device;
each of the wireless nodes receiving logical addresses from CEC capable devices wire attached to each of the wireless nodes;
each of the wireless nodes creating a proxy table that includes logical addresses of the CEC capable devices wire attached to an other of the wireless nodes;
each of the wireless nodes responding with a proxy acknowledgement when the wireless node receives a packet intended for at least one of the CEC capable devices that is wire connected to the other wireless node, wherein the wireless node has an establish link with the other wireless node.

2. The method of claim 1, wherein the proxy table of each wireless node, allows each wireless node to determine the logical address of CEC capable devices directly connected to other wireless nodes, and appropriately respond with proxy acknowledgements to CEC capable devices wire connected to the wireless node.

3. The method of claim 1, further comprising:
one of the wireless nodes receiving a message from an initiator CEC capable device, wherein the message is sent by the initiator CEC capable device to a particular destination logic address, and wherein the initiator CEC capable device is wire connected to the one wireless node;
the one wireless node wirelessly transmitting a control message to the other wireless node, the control message including the destination logical address and a logical address of the initiator CEC capable device;
the other wireless node checking its proxy table for the logical address of the initiator CEC capable device, if the proxy table of the other wireless node does not include the logical address of the initiator CEC capable device, then the other wireless node adding the logical address of the initiator CEC capable device to its proxy table.

4. The method of claim 3, further comprising:
the one wireless node checking its proxy table for the destination logical address;
if the at least one wireless node has the destination address within its proxy table, then the one wireless node responding to the message from the initiator device with an acknowledgement.

5. The method of claim 1, wherein the base CEC capable device comprises a display device.

6. The method of claim 1, further comprising:
one of the wireless nodes receiving a message from a CEC capable device, wherein the message is sent by the CEC capable device to a particular destination logic address, and wherein the CEC capable device is wire connected to the one wireless node;
the one wireless node wirelessly transmitting a control message to the other wireless node, the control message including the destination logical address;
the other wireless node sending a network message that includes the destination logical address over its wired network;
if the other wireless node does not receive an acknowledgement to the network message, the other wireless node wirelessly sending an error message back to the one wireless node;
the one wireless node removing the particular logical address from its proxy table upon receiving the error message.

7. The method of claim 1, further comprising:
a one of the wireless nodes cycling through and wirelessly transmitting messages that includes all possible CEC logical addresses;
the other wireless node receiving the messages, and sending network messages including the CEC logical addresses over its CEC network;
the other wireless node monitoring acknowledgements of CEC capable devices connected to its CEC network;
the other wireless node wirelessly transmitting back to the one wireless node information of which of the CEC logical addresses generated acknowledgements;
the one wireless node updating its proxy table based on the information received from the other wireless node.

8. A method of a wireless node aiding communication between CEC capable devices, comprising:
the wireless node receiving a physical addresses based on a physical location of the wireless node relative to a base CEC capable device;
the wireless nodes receiving logical addresses from CEC capable devices wire attached to the wireless node;
the wireless nodes creating a proxy table that includes logical addresses of the CEC capable devices wire attached to an other wireless node;
the wireless nodes responding with a proxy acknowledgement when the wireless node receives a packet intended for at least one of the CEC capable devices that is wire connected to the other wireless node, wherein the wireless node has an establish wireless link with the other wireless node.

9. The method of claim 8, wherein the proxy table of the wireless node, allows the wireless node to determine the logical address of CEC capable devices directly connected to other wireless nodes, and appropriately respond with proxy acknowledgements to CEC capable devices wire connected to the wireless node.

10. The method of claim 8, further comprising:
the wireless node receiving a message from an initiator CEC capable device, wherein the message is sent by the initiator CEC capable device to a particular destination logic address, and wherein the initiator CEC capable device is wire connected to the wireless node;
the wireless node wirelessly transmitting a control message to the other wireless node, the control message including the destination logical address and a logical address of the initiator CEC capable device;
the other wireless node checking its proxy table for the logical address of the initiator CEC capable device, if the proxy table of the other wireless node does not include the logical address of the initiator CEC capable device, then the other wireless node adding the logical address of the initiator CEC capable device to its proxy table.

11. The method of claim 10, further comprising:
the wireless node checking its proxy table for the destination logical address;
if the wireless node has the destination address within its proxy table, then the wireless node responding to the message from the initiator device with an acknowledgement.

12. The method of claim 8, wherein the base CEC capable device comprises a display device.

13. The method of claim 8, further comprising:
the wireless node receiving a message from a CEC capable device, wherein the message is sent by the CEC capable device to a particular destination logic address, and wherein the CEC capable device is wire connected to the wireless node;
the wireless node wirelessly transmitting a control message to the other wireless node, the control message including the destination logical address;
the wireless node sending a network message that includes the destination logical address over its wired network;
if the other wireless node does not receive an acknowledgement to the network message, the other wireless node wirelessly sending an error message back to the wireless node;
the wireless node removing the particular logical address from its proxy table upon receiving the error message.

14. The method of claim 8, further comprising:
the wireless node cycling through and wirelessly transmitting messages that includes all possible CEC logical addresses;
the other wireless node receiving the messages, and sending network messages including the CEC logical addresses over its CEC network;
the other wireless node monitoring acknowledgements of CEC capable devices connected to its CEC network;
the other wireless node wirelessly transmitting back to the one wireless node information of which of the CEC logical addresses generated acknowledgements;
the wireless node updating its proxy table based on the information received from the other wireless node.

15. A wireless network for maintaining communication between CEC networks, comprising:
a first wireless node receiving logical addresses from CEC capable devices wire attached to the first wireless node;
a second wireless node receiving logical addresses from CEC capable devices wire attached to the second wireless node;
the first wireless node creating a proxy table that includes logical addresses of the CEC capable devices wire attached to the second wireless node;
the second wireless node creating a proxy table that includes logical addresses of the CEC capable devices wire attached to the first wireless node;
the first wireless node responding with a proxy acknowledgement when the first wireless node receives a packet intended for at least one of the CEC capable devices that is wire connected to the second wireless node, wherein the first wireless node has an establish wireless link with the second wireless node;
the second wireless node responding with a proxy acknowledgement when the second wireless node receives a packet intended for at least one of the CEC capable devices that is wire connected to the first wireless node, wherein the second wireless node has an establish wireless link with the first wireless node.

16. A method of wireless nodes maintaining communication between devices, comprising:
assigning physical addresses to the wireless nodes based on a physical location of the two wireless nodes relative to a base device;
each of the wireless nodes receiving logical addresses from devices wire attached to each of the wireless nodes;
each of the wireless nodes creating a proxy table that includes logical addresses of the devices wire attached to an other of the wireless nodes;
each of the wireless nodes responding with a proxy acknowledgement when the wireless node receives a packet intended for at least one of the devices that is wire connected to the other wireless node, wherein the wireless node has an establish link with the other wireless node.

17. The method of claim 16, further comprising:
one of the wireless nodes receiving a message from an initiator device, wherein the message is sent by the initiator device to a particular destination logic address, and wherein the initiator device is wire connected to the one wireless node;
the one wireless node wirelessly transmitting a control message to the other wireless node, the control message including the destination logical address and a logical address of the initiator device;
the other wireless node checking its proxy table for the logical address of the initiator device, if the proxy table of the other wireless node does not include the logical address of the initiator device, then the other wireless node adding the logical address of the initiator device to its proxy table.

18. The method of claim 17, further comprising:
the one wireless node checking its proxy table for the destination logical address;
if the at least one wireless node has the destination address within its proxy table, then the one wireless node responding to the message from the initiator device with an acknowledgement.

19. The method of claim 16, further comprising:
one of the wireless nodes receiving a message from a device, wherein the message is sent by the device to a particular destination logic address, and wherein the device is wire connected to the one wireless node;
the one wireless node wirelessly transmitting a control message to the other wireless node, the control message including the destination logical address;
the other wireless node sending a network message that includes the destination logical address over its wired network;
if the other wireless node does not receive an acknowledgement to the network message, the other wireless node wirelessly sending an error message back to the one wireless node;
the one wireless node removing the particular logical address from its proxy table upon receiving the error message.

20. The method of claim 16, further comprising:
a one of the wireless nodes cycling through and wirelessly transmitting messages that includes all possible logical addresses;
the other wireless node receiving the messages, and sending network messages including the logical addresses over its network;
the other wireless node monitoring acknowledgements of devices connected to its network;
the other wireless node wirelessly transmitting back to the one wireless node information of which of the logical addresses generated acknowledgements;
the one wireless node updating its proxy table based on the information received from the other wireless node.
